(19) United States
(12) Patent Application Publication
(10) Pub. No.: US 2014/0344765 A1
(43) Pub. Date: Nov. 20, 2014

(54) Touch Sensitive UI Pinch and Flick Techniques for Managing Active Applications

(71) Applicant: barnesandnoble.com llc, New York, NY (US)

(72) Inventors: Kourtny M. Hicks, Sunnyvale, CA (US); Gerald B. Cueto, San Jose, CA (US)

(73) Assignee: barnesandnoble.com llc, New York, NY (US)

(21) Appl. No.: 13/897,331

(22) Filed: May 17, 2013

(51) Int. Cl. G06F 3/0488

(52) U.S. Cl. CPC G06F 3/04883
USPC 715/863

(57) ABSTRACT

Techniques are disclosed for managing active applications on a touch sensitive computing device using a pinch and flick gesture input, referred to collectively herein as a manage active apps mode. The manage active apps mode allows a user to perform a pinch gesture on a display of active applications to form a stack of those active applications. The user can then perform a flick gesture on the stack to perform a function on all of the active applications in the stack. The function may include closing, stopping, force stopping, quitting, or deleting the active applications in the stack, for example. In some cases, the manage active apps mode may be configured to provide feedback (e.g., an animation or sound) after a stack has been flicked to indicate that the function was performed (e.g., that the apps were closed, stopped, etc.).

### FIELD OF THE DISCLOSURE

This disclosure relates to computing devices, and more particularly, to user interface (UI) techniques for managing active applications on touch sensitive computing devices.

### BACKGROUND

Touch sensitive computing devices such as smart phones, eReaders, tablet computers, personal digital assistants (PDAs), and other such devices are commonly used for displaying consumable content and running multiple software applications (also known as applications or apps). The applications may vary based on the device, but may include applications in categories such as, for example, communications, entertainment, children, social, games, news and weather, tools and utilities, and productivity, just to name a few types. The devices are useful for displaying a user interface that allows a user to interact with the displayed content, such as content provided by the various applications. The touch sensitive computing device may receive user input from a touch screen or some other touch sensitive surface/interface, such as a track pad (e.g., in combination with a non-touch sensitive display). The user may interact with the touch sensitive interface using fingers, a stylus, or some other implement to provide input to the user interface.

### BRIEF DESCRIPTION OF THE DRAWINGS

FIGS. 1a-b illustrate an example touch sensitive computing device having a manage active apps mode configured in accordance with an embodiment of the present invention.

FIGS. 1c-d illustrate example configuration screen shots of the user interface of the touch sensitive computing device shown in FIGS. 1a-b configured in accordance with an embodiment of the present invention.

FIG. 2a illustrates a block diagram of a touch sensitive computing device configured in accordance with an embodiment of the present invention.

FIG. 2b illustrates a block diagram of a communication system including the touch sensitive computing device of FIG. 2a configured in accordance with an embodiment of the present invention.

FIGS. 3a-f collectively illustrate an example manage active apps mode pinch and flick input for closing a list of active applications, in accordance with an embodiment of the present invention.

FIGS. 4a-c collectively illustrate an example manage active apps mode flick gesture, where the direction of the flick determines the mode function performed, in accordance with an embodiment of the present invention.

FIGS. 5a-c illustrate an example manage active apps mode separate action using a spread gesture to separate a previously formed stack of active applications, in accordance with an embodiment of the present invention.

FIG. 6 illustrates a method for providing a manage active apps mode in a touch sensitive computing device, in accordance with one or more embodiments of the present invention.

### DETAILED DESCRIPTION

Techniques are disclosed for managing active applications on a touch sensitive computing device using a pinch and flick gesture input, generally referred to herein as a manage active apps mode. The manage active apps mode allows a user to perform a pinch gesture on a display of active applications to form a stack of those active applications. The user can then perform a flick gesture on the stack to perform a function on all of the active applications in the stack. The function may include, for example, closing, stopping, force stopping, quitting, or deleting the active applications in the stack. In some cases, the manage active apps mode may further include an action, such as a spread gesture, that separates a previously formed stack. In some cases, the manage active apps mode may be configured to provide feedback (e.g., an animation or sound) after a stack has been flicked to indicate that the function was performed (e.g., that the apps were closed, stopped, etc.). Numerous other configurations and variations will be apparent in light of this disclosure.

General Overview

As previously described, touch sensitive computing devices such as tablets, eReaders, and smart phones are commonly used for displaying user interfaces and consumable content, and are generally configured to run multiple software applications (also known as applications or apps) at the same time. In this manner, a device can have multiple applications active at the same time. Some applications may become active automatically (e.g., when the device is powered on) or manually (e.g., when a user selects the specific application), for example. In some instances, a user may desire to manage all of the device's active applications by closing (or stopping, deleting, etc.) all of them at the same time. For example, the user may desire to manage all of the active applications to start a new set of active applications or to save device memory, power, or data usage.

Thus, and in accordance with one or more embodiments of the present invention, techniques are disclosed for managing active applications on a touch sensitive computing device using a pinch and flick gesture input, generally referred to herein as a manage active apps mode. As will be apparent in light of this disclosure, a pinch gesture can be performed on a display of active applications to form a stack of the active applications. As used herein, “pinch” and “pinch gesture” refer, in addition to their ordinary meaning, to making contact (whether direct or proximate) with a touch sensitive surface/interface using two or more fingers and then bringing those fingers toward each other or together. After a stack is formed, a flick gesture performed on the stack can be used to perform a function on all of the active applications in the stack. As used herein, “flick” and “flick gesture” refer, in addition to their ordinary meaning, to making contact (whether direct or proximate) with a touch sensitive surface/interface using one or more fingers and then making a throwing, swiping, and/or dragging motion. The function caused by flicking the stack may include, for example, closing, stopping, force stopping, quitting, and/or deleting all of the active applications in the stack. In some cases, the pinch and/or flick gesture may be made with the assistance of a stylus or other implement. For example, in some embodiments of the manage active apps mode, after a list of active applications is pinched to form them into a stack (e.g., using two fingers), a stylus may be used to flick the stack off of the touch screen to close (or stop, delete, etc.) all of the active applications in that stack.

As used herein, “application(s)” and “app(s)” refer, in addition to their ordinary meaning, to software or programs for a computing device that serve a user in some capacity or help a user perform an activity, task, or job. As used herein, “active” used in conjunction with application(s) and app(s) refers, in addition to its ordinary meaning, to being currently running, open, or displayed in the foreground and/or background. “Active” may also refer to using device memory, power, and/or data. Applications included in a display of active applications (e.g., a list of active applications) may include any application made active automatically (e.g., when the device is powered on) and/or manually (e.g., started by a user). However, a list of active applications need not include every application active on the device. For example, some devices may separate active applications into categories, such that the techniques described herein can be used on one categorical list of active applications (e.g., active entertainment applications). In such an example, a pinch and flick input may be used to close all of the active entertainment applications, without affecting the active applications in any other category. In another example, in devices that include multiple user profiles, lists of active applications may be specific to each user profile. In such an example, a pinch and flick input may be used to close the active applications of one user profile, without affecting the active applications of any other user profile. In still other embodiments, some active applications may effectively be designated as exempt (based on user-configuration and/or hard-coded), such that those applications are not affected by a pinch and flick input of the manage active apps mode (e.g., even if they are active and included in the stack, the pinch and flick based function will not operate on exempted apps). As will be apparent in light of this disclosure, the manage active apps mode can be used on any display of active applications, whether that display is a list, group, grid, menu, icon layout, or any other suitable display.

The functions available using the manage active apps mode may vary based on the device and/or the device's user interface (or operating system), as will be apparent in light of this disclosure. In some embodiments, closing active applications may stop them from running in the foreground, but one or more of the closed applications may still run in the background or may continue to cause use of device memory, power, and/or data. In some such embodiments, stopping, force stopping, or quitting active applications may stop them from running in both the foreground and the background. In other embodiments, managing active applications may include other functions, such as force quitting, ending, or killing active applications, or even deleting (removing/uninstalling) applications. In some embodiments, managing active applications may include any function that makes the applications inactive in some manner. In some embodiments, the function performed on all of the active applications in the stack may be determined by the characteristics of the flick gesture (e.g., the direction of the flick). For example, in one embodiment, flicking the stack to the left closes the active applications in the stack and flicking the stack to the right force stops the active applications and flicking the stack to downward deletes the active applications. With respect to deleting apps, a special gesture and/or confirmation can be used. For instance, if the user flicks stack away before releasing from the pinch gesture (such that pinch and flick are effectively one continuous gesture), then a delete/removal of that applications in the stack would be executed, in accordance with one embodiment. The user may also be prompted to confirm the deletion mode, if so desired. Applications required or otherwise restricted can be excluded or otherwise exempted from any such deletion requests, as previously explained. Allowing a user to select the function performed on the stack of active applications, e.g., based on the direction and/or nature of the flick gesture, may enhance the user's experience when managing active applications.

In some embodiments, the manage active apps mode may include a gesture for separating a previously formed stack of active applications prior to performing a flick gesture. In some such embodiments, a spread gesture performed on the stack, for example, may be used to restore all of the active applications into their original list (to undo forming the stack). In some embodiments, the manage active apps mode may be configured to provide feedback to indicate that the active applications have been closed (or stopped, force stopped, etc.) after the flick gesture has been performed. For example, the feedback may be visual (e.g., an animation or text is displayed), auditory (e.g., a notification sound is played), and/or tactile (e.g., a vibration is provided). In some embodiments, the manage active apps mode pinch and flick may be made using one continuous gesture (by maintaining contact between the pinch gesture and flick gesture), as will be discussed in turn.

In some embodiments, the manage active apps mode may be configured at a device level (based on the settings of the electronic device or administrative user) and/or at a user profile level (based on the specific user profile being used). For example, in devices having multiple user profiles, the manage active apps mode may be configured to close the active applications in response to a pinch and flick input when one user profile is active, whereas it may be configured to stop the active applications in response to the same pinch and flick input in another user profile. To this end, the manage active apps mode may be user-configurable, hard-coded, or some combination thereof (e.g., where some aspects are user-configurable and others are hard-coded). Further, the manage active apps mode as variously described herein may be included initially with the user interface (or operating system) of a touch sensitive computing device or be a separate program/service/application configured to interface with an already existing UI for a touch sensitive computing device to incorporate the functionality of the manage active apps mode as variously described herein. In some instances, the manage active apps mode may come as a non-transient computer program product comprising a set of instructions. For ease of reference, user input (e.g., the input used for the pinch and flick gestures) is sometimes referred to as contact or user contact. However, direct and/or proximate contact (e.g., hovering within a few centimeters of the touch sensitive surface) may be used to perform gestures as variously described herein depending on the specific touch sensitive device/interface being used. In other words, in some embodiments, a user may be able to use the manage active apps mode without physically touching the touch sensitive device, as will be apparent in light of this disclosure.

Device and Configuration Examples

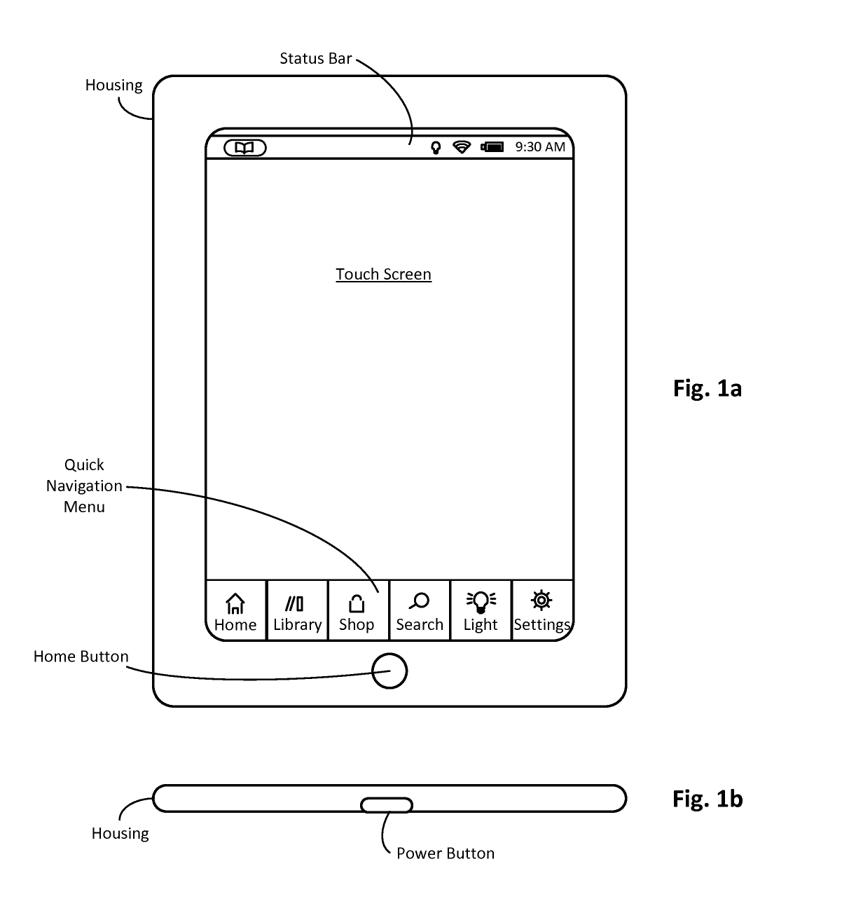

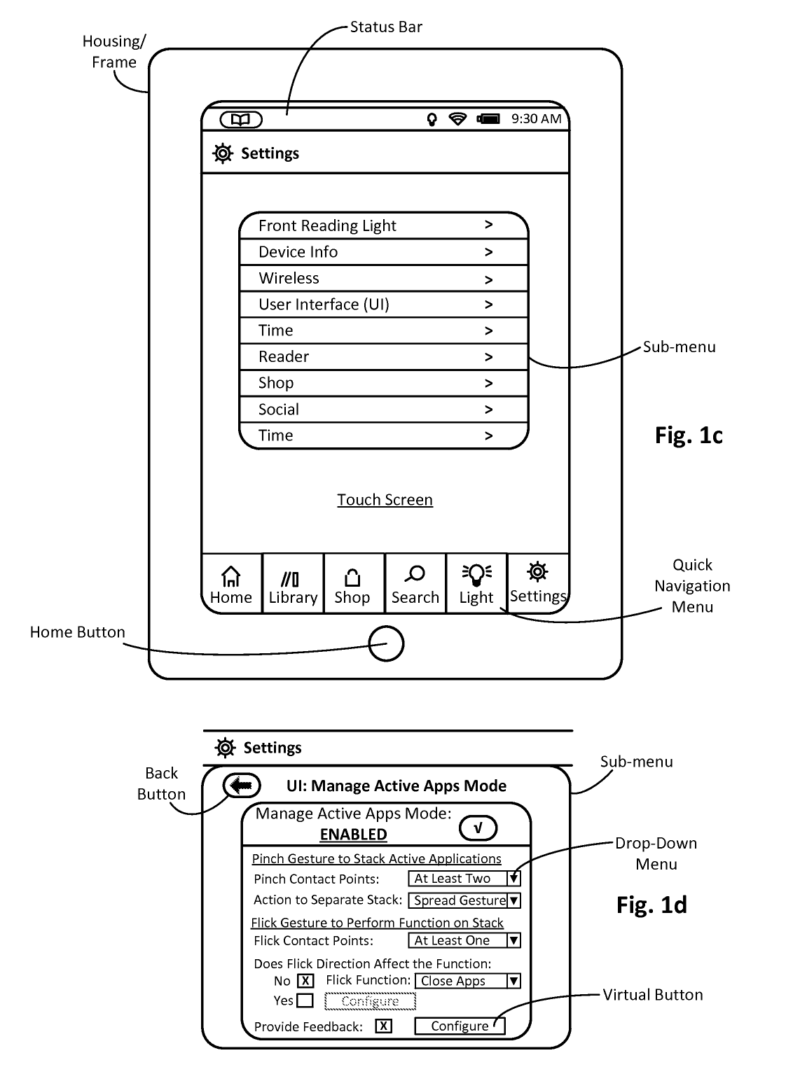

FIGS. 1a-b illustrate an example touch sensitive computing device having a manage active apps mode configured in accordance with an embodiment of the present invention. The device could be, for example, a tablet computer such as the NOOK® Tablet by Barnes & Noble. In a more general sense, the device may be any electronic device having a touch sensitive user interface and capability for displaying content to a user, such as a mobile phone or mobile computing device such as an eReader, a tablet or laptop, a desktop computing system, a television, a smart display screen, or any other device having a touch screen display or a non-touch display screen that can be used in conjunction with a touch sensitive surface/interface. As will be appreciated in light of this disclosure, the claimed invention is not intended to be limited to any particular kind or type of touch sensitive computing device.

As can be seen with this example configuration, the device comprises a housing/frame that includes a number of hardware features such as a power button and a press-button (sometimes called a home button herein). A touch screen based user interface (UI) is also provided, which in this example embodiment includes a quick navigation menu having six main categories to choose from (Home, Library, Shop, Search, Light, and Settings) and a status bar that includes a number of icons (a night-light icon, a wireless network icon, and a book icon), a battery indicator, and a clock. Other embodiments may have fewer or additional such UI touch screen controls and features, or different UI touch screen controls and features altogether, depending on the target application of the device. Any such general UI controls and features can be implemented using any suitable conventional or custom technology, as will be appreciated. Although the touch sensitive computing device shown in FIGS. 1 a-d uses a touch screen display, other embodiments may include a non-touch screen and a touch sensitive surface such as a track pad, or a touch sensitive housing configured with one or more acoustic sensors, etc. For ease of description, examples are provided with touch screen technology.

The power button can be used to turn the device on and off, and may be used in conjunction with a touch-based UI control feature that allows the user to confirm a given power transition action request (e.g., such as a slide bar or tap point graphic to turn power off). In this example device, the home button is a physical press-button that can be used as follows: when the device is awake and in use, tapping the button will display the device's home screen or holding the button will display an active apps screen (e.g., a list of active applications). Numerous other configurations and variations will be apparent in light of this disclosure, and the claimed invention is not intended to be limited to any particular set of hardware buttons or features, or device form factor.

Continuing from FIG. 1a, the user can access a close apps configuration sub-menu, such as the one shown in FIG. 1d by tapping or otherwise selecting the Settings option in the quick navigation menu, which causes the device to display the general sub-menu shown in FIG. 1c. From this general sub-menu the user can select any one of a number of options, including one designated User Interface (UI) in this specific example case. Selecting this sub-menu item (with, for example, an appropriately placed screen tap) may cause the manage active apps mode configuration sub-menu of FIG. 1d to be displayed, in accordance with an embodiment. In other example embodiments, selecting the User Interface (UI) option may present the user with a number of additional sub-options, one of which may include a so-called manage active apps mode option, which may then be selected by the user so as to cause the manage active apps mode configuration sub-menu of FIG. 1d to be displayed. Any number of such menu schemes and nested hierarchies can be used, as will be appreciated in light of this disclosure. In other embodiments, the manage active apps mode may be hard-coded such that no configuration is needed or otherwise permitted. The degree of hard-coding versus user-configurability can vary from one embodiment to the next, and the claimed invention is not intended to be limited to any particular configuration scheme of any kind, as will be appreciated in light of this disclosure.

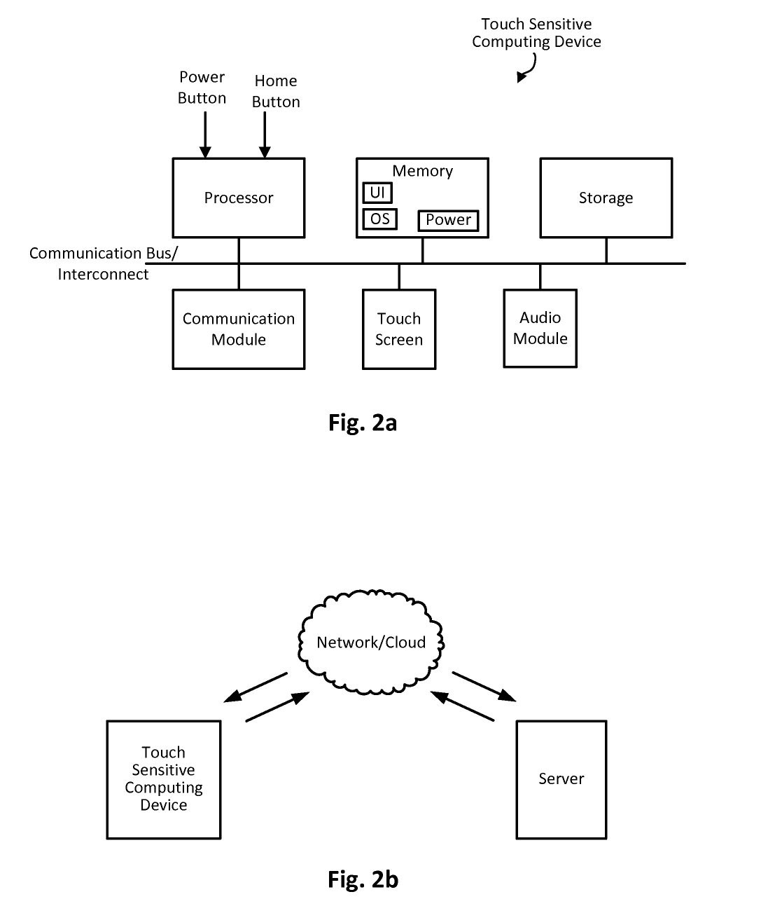

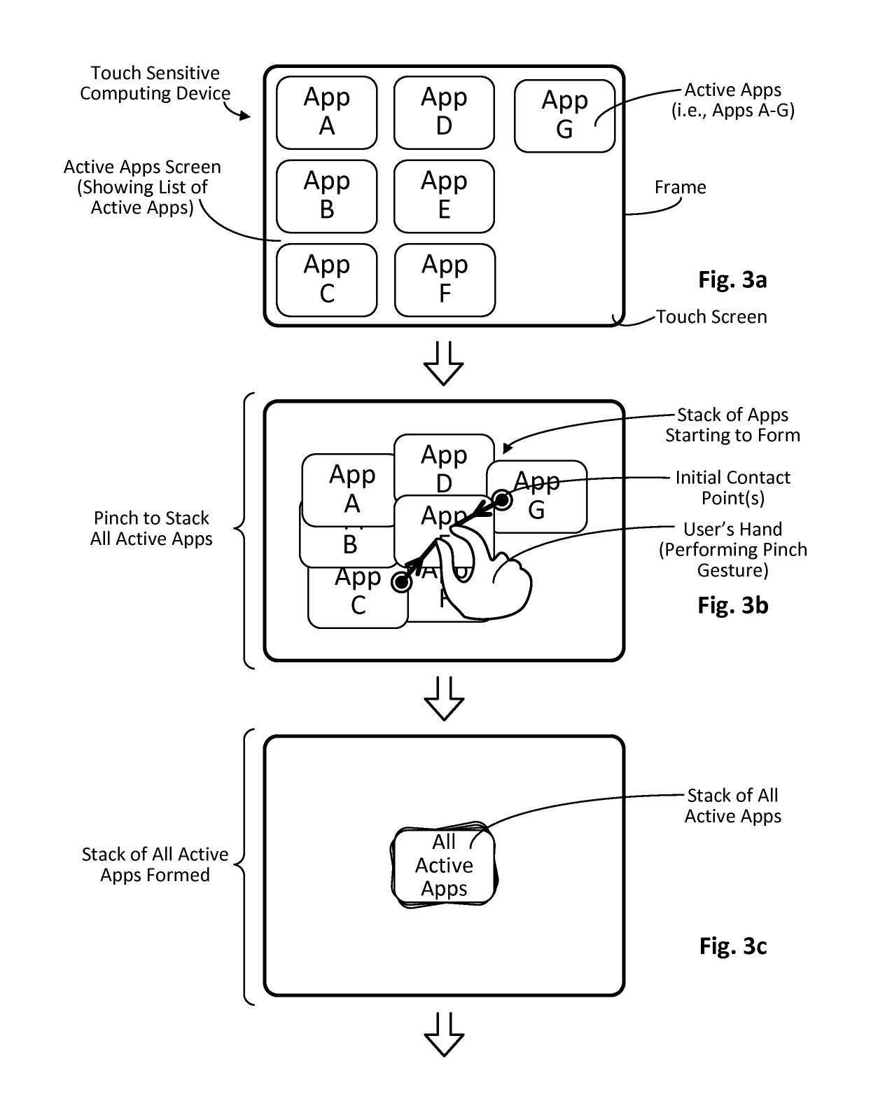

As will be appreciated, the various UI control features and sub-menus displayed to the user are implemented as UI touch screen controls in this example embodiment. Such UI touch screen controls can be programmed or otherwise configured using any number of conventional or custom technologies. In general, the touch screen translates one or more touches (whether direct or proximate and whether made by a user's hand, a stylus, or some other suitable implement) in a particular location(s) into an electrical signal which is then received and processed by the underlying operating system (OS), system software, and circuitry (processor, etc.) of the touch sensitive computing device. In some instances, note that the user need not actually physically touch the touch sensitive surface/interface to provide user input (e.g., when the touch sensitive surface/interface recognizes hovering input). Additional example details of the underlying OS and circuitry in accordance with some embodiments will be discussed in turn with reference to FIG. 2a. In some cases, the manage active apps mode may be automatically configured by the specific UI or user profile being used. In these instances, the manage active apps mode need not be user-configurable (e.g., if the manage active apps mode is hard coded or is otherwise automatically configured).

As previously explained, and with further reference to FIGS. 1c and 1d, once the Settings sub-menu is displayed (FIG. 1c), the user can then select the User Interface (UI) option. In response to such a selection, the manage active apps mode configuration sub-menu shown in FIG. 1d can be provided to the user. In this example case, the manage active apps mode configuration sub-menu includes a UI check box that when checked or otherwise selected by the user, effectively enables the manage active apps mode (shown in the Enabled state); unchecking the box disables the mode. Other embodiments may have the manage active apps mode always enabled, or enabled by a switch or button, for example. In some instances, the manage active apps mode may be automatically enabled in response to an action, such as when a list or group of active applications is displayed, for example. As previously described, the user may be able to configure some of the features with respect to the manage active apps mode, so as to effectively give the user a say in, for example, the function performed using a pinch and flick method as variously described herein, if so desired.

In the example case shown in FIG. 1d, once the manage active apps mode is enabled, the user can choose various options related to the pinch gesture and the flick gesture used to perform manage active apps mode functions that will be discussed in turn. The Pinch Gesture to Stack Active Applications settings section provides two selectable settings. The first selectable setting allows a user to set the Pinch Contact Points, shown set as At Least Two. The pinch contact points relate to the number of contact points needed to make the pinch gesture to stack a list or group of active applications using one or more embodiments of the manage active apps mode. Therefore, at the shown setting of at least two contact points, the pinch gesture can be made using, for example two or more fingers. Other selections for the pinch contact points option may be selected using the drop-down menu (as is the case for other selectable options described herein), and may include at least three, exactly two, or exactly three, just to name a few examples. The Pinch Gesture to Stack Active Applications settings section also includes an Action to Restore List selectable option. This option allows the user to set an action for essentially undoing a previously formed stack of active applications (using a pinch gesture as variously described herein). In this manner, the list or group of active applications can be restored to its original state. The action to restore the active applications list is shown set as a Spread Gesture, meaning that a spread gesture performed on a previously formed stack of applications can be used to restore a list of active applications. Other selections for the action to restore the active applications list may include a double tap on the stack, a press-and-hold on the stack, or exiting the active applications list screen before flicking the stack (e.g., exiting to a home screen), just to name a few examples.

Continuing with the example settings screen shown in FIG. 1d, the Flick Gesture to Perform Function on Stack section provides three selectable settings. The first selectable setting allows a user to set the Flick Contact Points, shown set as At Least One. The flick contact points relate to the number of contact points needed to make the flick gesture on a stack of active applications to perform a function on all of the applications in the stack. Therefore, at the shown setting of at least one contact point, the flick gesture can be made using, for example, one or more fingers. Other selections for the flick contact points option may include at least two, exactly one, or exactly two, just to name a few examples. In some embodiments, the number of flick contact points can be used to specify the desired function, as will be appreciated in light of this disclosure. In one example such embodiment, the configuration screen may allow the user to specify multiple “flick gesture/function” pairs (e.g., 1-point flick/close apps, 2-point flick/delete apps, etc).

The next selectable setting shown in the example of FIG. 1d—Does Flick Direction Affect the Function—relates to whether or not the direction of the flick gesture affects the function performed. This setting is shown set at No (the No box is selected). In this configuration, the flick direction does not affect the function, allowing the user to set the flick function performed regardless of the direction of the flick. The Flick Function is set at Close Apps, meaning that this example embodiment of the manage active apps mode would close all of the eligible active applications in the stack when a stack is flicked (e.g., flicked off of the screen). Other selections for the flick function may include stop apps, force stop apps, quit apps, and delete apps, just to name a few examples.

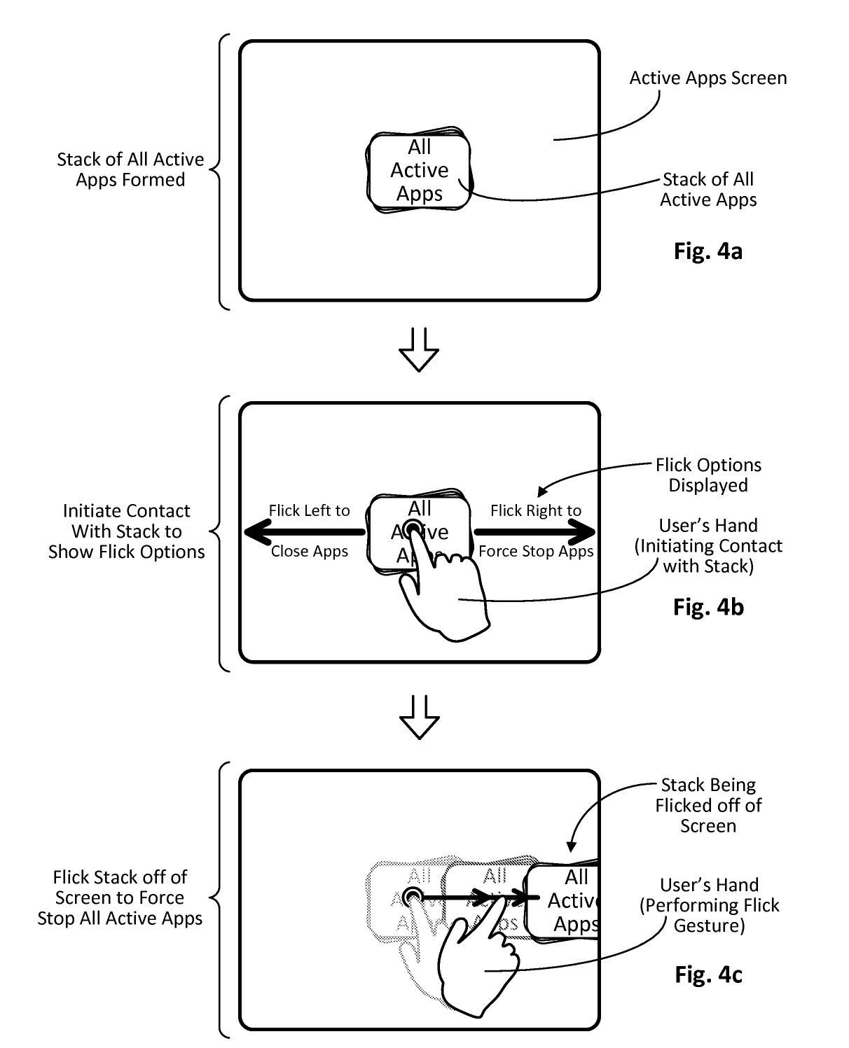

If the flick does affect the function (if the Yes box is selected) in this example case, then the user can further configure the manage active apps mode to assign various functions (e.g., close apps, stop apps, delete apps, etc.) to flick directions, as will be apparent in light of this disclosure. This can be achieved, for example, by selecting the Configure button next to the Yes box when the Yes box is selected. For example, the user may be able to set that flicking the stack to the left closes the applications in the stack and flicking the stack to the right force stops the applications, as shown in FIG. 4b. The direction of the flicking may also be related to the orientation of the device, such that a left flick performed when the device is in a portrait orientation can cause the same function (e.g., close apps) as an up flick performed when the device is in a landscape orientation, and a right flick performed when the device is in a portrait orientation causes the same function (e.g., force stop apps) as an up flick performed when the device is in a landscape orientation, for example.

The next settings option under the flick gesture section shown in FIG. 1d allows a user to set whether or not the manage active apps mode will Provide Feedback when the flick function is performed (shown selected to provide feedback). When selected (which is the case in this example), the user may be able to configure the type of feedback provided by the manage active apps mode. For example, this may include selecting from various visual, auditory, and/or tactile feedback types. Visual feedback used to indicate that the flick function was performed may include various animations (e.g., the popping of a balloon), transition effects (e.g., fading out to the home screen), or textual displays (e.g., a display of “No Active Apps”); auditory feedback may include various sounds (e.g., a beeping sound) or music (e.g., a quick tune); and tactile feedback may include vibrating the device, just to name a few examples. Numerous configurations and features of the manage active apps mode will be apparent in light of this disclosure.

In one or more embodiments, the user may specify the user profiles in which the manage active apps mode is available. Such a configuration feature may be helpful, for instance, in a smart phone or tablet computer or other multifunction computing device that includes multiple user profiles (as opposed to a device having only one user profile). In one example case, for instance, the administrative user of the device may be able to designate which user profiles can use the manage active apps mode as variously described herein, or determine whether or not the users have access to configure the manage active apps mode. In some embodiments, the manage active apps mode may also be related or tied to another aspect of the device's UI (or operating system), such that the manage active apps mode is only available when the other aspect is running or invoked. For example, the manage active apps mode may only be available, active, or running when an active apps screen is displayed (e.g., using an active apps button).

As can be further seen in FIG. 1d, a back button arrow UI control feature may be provisioned on the touch screen for any of the menus provided, so that the user can go back to the previous menu, if so desired. Note that configuration settings provided by the user can be saved automatically (e.g., user input is saved as selections are made or otherwise provided). Alternatively, a save button or other such UI feature can be provisioned, which the user can engage as desired. Again, while FIGS. 1c and 1d show user configurability, other embodiments may not allow for any such configuration, wherein the various features provided are hard-coded or otherwise provisioned by default. The degree of hard-coding versus user-configurability can vary from one embodiment to the next, and the claimed invention is not intended to be limited to any particular configuration scheme of any kind.

Architecture

FIG. 2a illustrates a block diagram of a touch sensitive computing device configured in accordance with an embodiment of the present invention. As can be seen, this example device includes a processor, memory (e.g., RAM and/or ROM for processor workspace and storage), additional storage/memory (e.g., for content), a communications module, a touch screen, and an audio module. A communications bus and interconnect is also provided to allow inter-device communication. Other typical componentry and functionality not reflected in the block diagram will be apparent (e.g., battery, co-processor, etc.). Further note that although a touch screen display is provided, other embodiments may include a non-touch screen and a touch sensitive surface such as a track pad, or a touch sensitive housing configured with one or more acoustic sensors, etc. In this manner, a non-touch sensitive computing device can become a touch sensitive computing device by adding an interfacing touch sensitive component. The principles provided herein equally apply to any such touch sensitive devices. For ease of description, examples are provided with touch screen technology.

The touch sensitive surface (touch sensitive display or touch screen, in this example) can be any device that is configured with user input detecting technologies, whether capacitive, resistive, acoustic, active or passive stylus, and/or other input detecting technology. The screen display can be layered above input sensors, such as a capacitive sensor grid for passive touch-based input (e.g., with a finger or passive stylus in the case of a so-called in-plane switching (IPS) panel), or an electro-magnetic resonance (EMR) sensor grid (e.g., for sensing a resonant circuit of the stylus). In some embodiments, the touch screen display can be configured with a purely capacitive sensor, while in other embodiments the touch screen display may be configured to provide a hybrid mode that allows for both capacitive input and active stylus input. In any such embodiments, a touch screen controller may be configured to selectively scan the touch screen display and/or selectively report contacts detected directly on or otherwise sufficiently proximate to (e.g., within a few centimeters) the touch screen display. The proximate contact may include, for example, hovering input used to cause location specific input as though direct contact were being provided on a touch sensitive surface (such as a touch screen). Numerous touch screen display configurations can be implemented using any number of known or proprietary screen based input detecting technology.

Continuing with the example embodiment shown in FIG. 2a, the memory includes a number of modules stored therein that can be accessed and executed by the processor (and/or a co-processor). The modules include an operating system (OS), a user interface (UI), and a power conservation routine (Power). The modules can be implemented, for example, in any suitable programming language (e.g., C, C++, objective C, JavaScript, custom or proprietary instruction sets, etc.), and encoded on a machine readable medium, that when executed by the processor (and/or co-processors), carries out the functionality of the device including a manage active apps mode as variously described herein. The computer readable medium may be, for example, a hard drive, compact disk, memory stick, server, or any suitable non-transitory computer/computing device memory that includes executable instructions, or a plurality or combination of such memories. Other embodiments can be implemented, for instance, with gate-level logic or an application-specific integrated circuit (ASIC) or chip set or other such purpose built logic, or a microcontroller having input/output capability (e.g., inputs for receiving user inputs and outputs for directing other components) and a number of embedded routines for carrying out the device functionality. In short, the functional modules can be implemented in hardware, software, firmware, or a combination thereof.

The processor can be any suitable processor (e.g., 800 MHz Texas Instruments® OMAP3621 applications processor), and may include one or more co-processors or controllers to assist in device control. In this example case, the processor receives input from the user, including input from or otherwise derived from the power button, home button, and touch sensitive surface. The processor can also have a direct connection to a battery so that it can perform base level tasks even during sleep or low power modes. The memory (e.g., for processor workspace and executable file storage) can be any suitable type of memory and size (e.g., 256 or 512 Mbytes SDRAM), and in other embodiments may be implemented with non-volatile memory or a combination of non-volatile and volatile memory technologies. The storage (e.g., for storing consumable content and user files) can also be implemented with any suitable memory and size (e.g., 2 GBytes of flash memory).

The display can be implemented, for example, with a 6-inch E-ink Pearl 800×600 pixel screen with Neonode® zForce® touch screen, or any other suitable display and touch screen interface technology. The communications module can be, for instance, any suitable 802.11b/g/n WLAN chip or chip set, which allows for connection to a local network so that content can be downloaded to the device from a remote location (e.g., content provider, etc, depending on the application of the display device). In some specific example embodiments, the device housing that contains all the various componentry measures about 6.5″ high by about 5″ wide by about 0.5″ thick, and weighs about 6.9 ounces. Any number of suitable form factors can be used, depending on the target application (e.g., laptop, desktop, mobile phone, etc.). The device may be smaller, for example, for smart phone and tablet applications and larger for smart computer monitor and laptop applications.

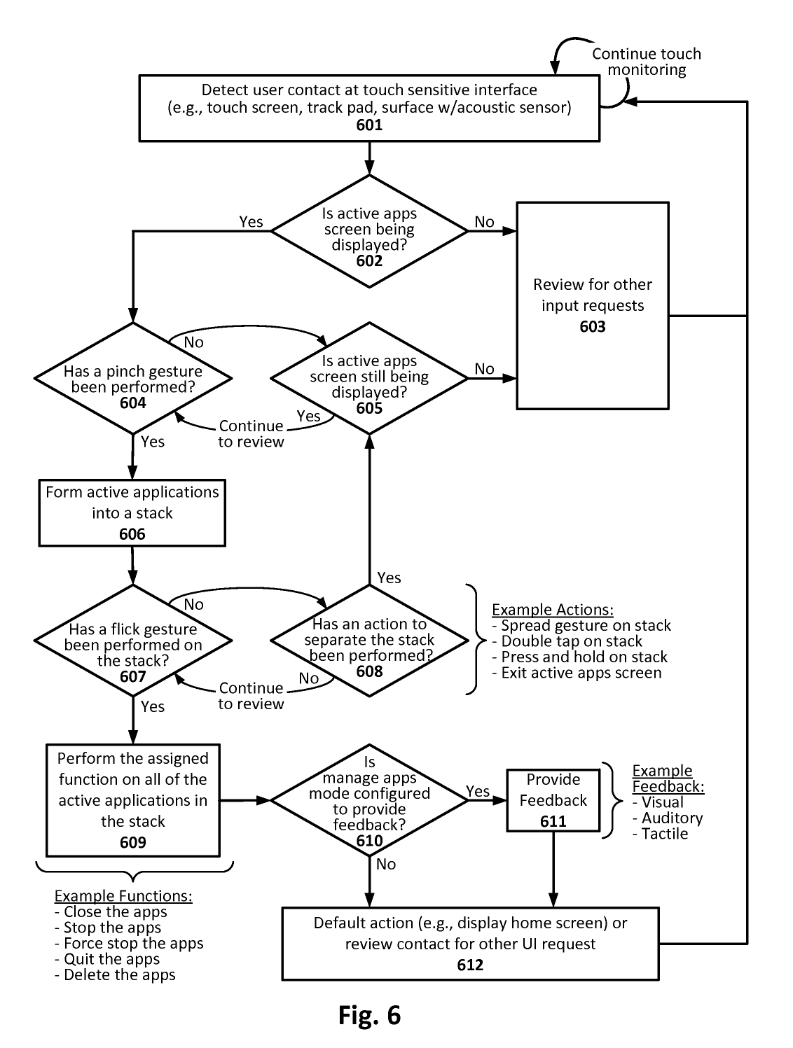

The operating system (OS) module can be implemented with any suitable OS, but in some example embodiments is implemented with Google Android OS or Linux OS or Microsoft OS or Apple OS. In other example embodiments, the OS module may be implemented with any OS that can run multiple applications and has a UI capable of displaying a list (or group) of active applications. The power management (Power) module can be configured as typically done, such as to automatically transition the device to a low power consumption or sleep mode after a period of non-use. A wake-up from that sleep mode can be achieved, for example, by a physical button press and/or a touch screen swipe or other action. The UI module can be, for example, based on touch screen technology, and the various example screen shots and example use-cases shown in FIGS. 1a, 1c-d, 3a-f, 4a-c, and 5a-c, in conjunction with the manage active apps mode methodologies demonstrated in FIG. 6, which will be discussed in turn. The audio module can be configured, for example, to speak or otherwise aurally present a selected eBook or other textual content, or to aurally present a confirmation query regarding a given pinch and flick gesture (e.g., verbal prompt, “Delete active apps in stack”?). In some example cases, if additional space is desired, for example, to store digital books or other content and media, storage can be expanded via a microSD card or other suitable memory expansion technology (e.g., 32 GBytes, or higher).

Client-Server System

FIG. 2b illustrates a block diagram of a communication system including the touch sensitive computing device of FIG. 2a configured in accordance with an embodiment of the present invention. As can be seen, the system generally includes a touch sensitive computing device that is capable of communicating with a server via a network/cloud. In this example embodiment, the touch sensitive computing device may be, for example, an eReader, a mobile phone, a smart phone, a laptop, a tablet, a desktop computer, or any other touch sensitive computing device. The network/cloud may be a public and/or private network, such as a private local area network operatively coupled to a wide area network such as the Internet. In this example embodiment, the server may be programmed or otherwise configured to receive content requests from a user via the touch sensitive device and to respond to those requests by providing the user with requested or otherwise recommended content. In some such embodiments, the server may be configured to remotely provision a manage active apps mode as provided herein to the touch sensitive device (e.g., via JavaScript or other browser based technology). In other embodiments, portions of the methodology may be executed on the server and other portions of the methodology may be executed on the device. Numerous server-side/client-side execution schemes can be implemented to facilitate a manage active apps mode in accordance with one or more embodiments, as will be apparent in light of this disclosure.

Manage Active Apps Mode Examples

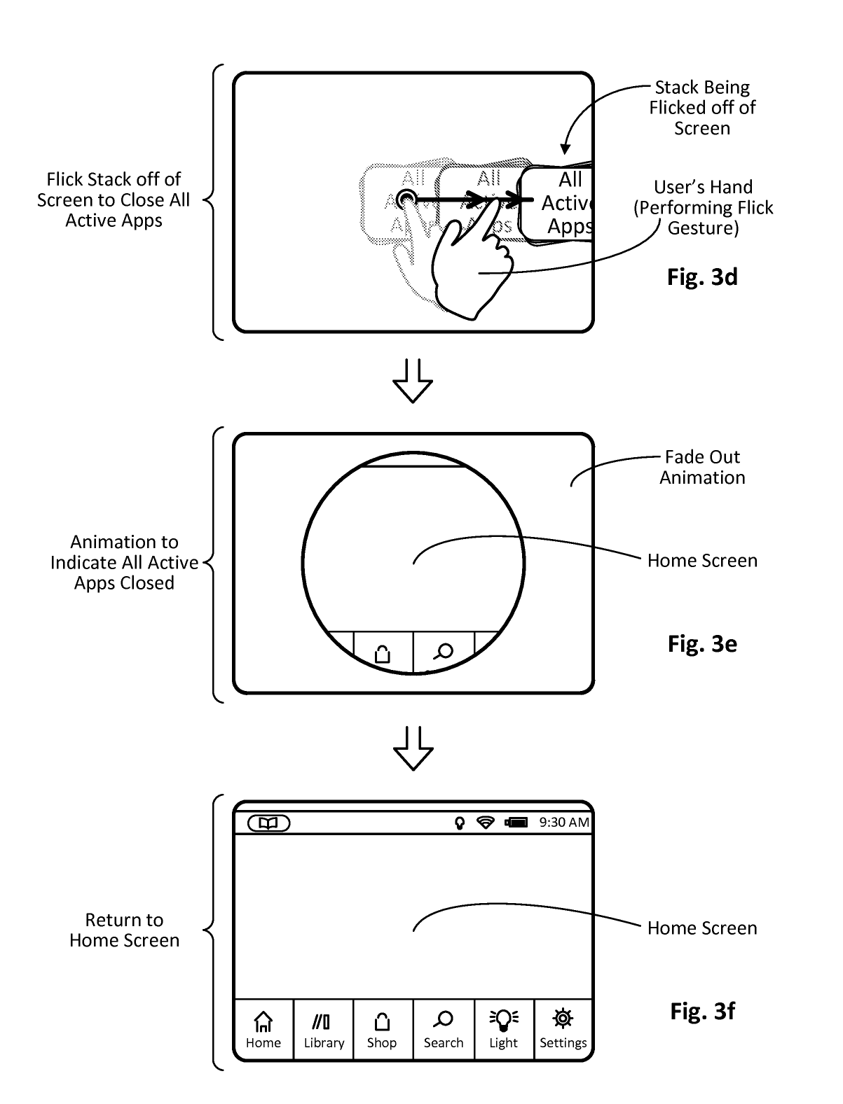

FIGS. 3a-e collectively illustrate an example manage active apps mode pinch and flick input for closing a list of active applications, in accordance with an embodiment of the present invention. FIG. 3a illustrates a screen shot of an example touch sensitive computing device having a manage active apps mode configured in accordance with one or more embodiments of the present invention. The touch sensitive computing device includes a frame that houses a touch sensitive surface, which in this example, is a touch screen display. In some embodiments, the touch sensitive surface may be separate from the display, such as is the case with a track pad. As previously described, any touch sensitive surface/interface for receiving user input (e.g., via direct contact or hovering input) may be used to perform the pinch and flick gestures (and other gestures) as variously described herein.

The screen shot in FIG. 3a shows a list of active applications and is referred to herein as an active apps screen. As previously described, a user may access and display the active apps screen by, for example, holding the home button, by pressing an active or recent apps button (whether a hardware button or virtual button), or through any other suitable method. The active apps screen may show active applications in various formats, such as in a list, group, grid, menu, icon layout, or any other suitable display. In some instances, a user may be able to switch between active applications from the active apps screen. In some instances, the active apps screen may be displayed on a portion of the entire display (e.g., on a portion of the touch screen), such as only half of the display. In other instances, the active apps screen may take up the entire display area, such as is shown in the example screen shot of FIG. 3a. Continuing with FIG. 3a, seven active applications are shown, i.e., Apps A-G. Although the manage active apps mode is illustrated herein as performing a function on all of the active applications in the active apps screen, it may be used to perform a function on a smaller list or group of applications. For example, if the active applications were divided into categories (e.g., entertainment apps, game apps, utility apps, etc.), then the manage active apps mode may be used to close all of the active applications in a particular category using a pinch and flick method on the list of applications within that category. In still another embodiment, the user can select various ones of the active apps displayed (e.g., with appropriately placed screen taps), thereby giving the user greater control of which apps are to be operated on. In such a case, the selected apps can be highlighted or otherwise visually accentuated so that the user can see which apps have been selected and will be acted upon.

FIG. 3b illustrates a pinch gesture used to form a stack of the targeted active applications in the active apps screen (which may be a sub-set of those active apps, as will be appreciated in light of this disclosure). In this example, a user is using two fingers (from the user's hand) to perform a pinch gesture. In some embodiments, the pinch may be initiated on one of the applications in the active apps screen to form the active applications into a stack. In other embodiments, the pinch may be initiated anywhere on the active apps screen to form the active applications into a stack. As shown in FIG. 3b, the user is performing a pinch gesture in the active apps screen to cause the active applications to form into a stack. The initial contact points and path of the pinch gesture are shown in FIG. 3b for illustrative purposes and generally are not shown when implementing the pinch gesture of the manage active apps mode. Once the pinch gesture is completed, the stack of all of the active applications is formed as shown, for example, in FIG. 3c. Although the active applications are shown transitioning into a stack in FIG. 3b while the pinch gesture is being performed, some embodiments of the manage active apps mode may show the stack after the pinch gesture is completed. The stack of active applications may be represented in various ways, such as by the stack graphic shown in FIG. 3c, by a folder, or by any other suitable visual representation showing the targeted apps in a stacked fashion.

After the stack of the active applications is formed (e.g., as shown in FIG. 3c), the user can perform a flick gesture on the stack to close all of the active applications as illustrated in FIG. 3d. As shown, a user is using one finger (from the user's hand) to perform a flick gesture. In some embodiments, the flick gesture may be initiated on the stack of active applications, while in other embodiments, the flick gesture may be initiated anywhere on the active apps screen. As shown in FIG. 3d, the flick gesture was initiated on the stack of active applications (the initial contact point and path of the flick gesture are shown for illustrative purposes and generally are not shown when implementing the flick gesture of the manage active apps mode). In the embodiment shown in FIG. 3d, the flick gesture was performed in such a manner so as to flick the stack of active applications off of the display (off of the touch screen) to perform the assigned function (e.g., close apps, stop apps, force stop apps, etc.) on all of the active applications in the stack.

In some embodiments, the flick gesture may have to reach a certain threshold (e.g., based on speed, distance, etc.) to cause the stack to go off of the screen (e.g., by flicking it or throwing it off). In other embodiments, the user may have to flick, swipe, or drag the stack off of the screen to cause the stack to go off the screen, i.e., the user may have to maintain contact (whether direct or proximate) with the touch sensitive surface until the edge of the touch screen is reached or nearly reached. In some embodiments, the pinch and flick method may have to be performed using one continuous gesture, i.e., without losing contact (whether direct or proximate) with the touch sensitive surface/interface. In the example shown in FIG. 3d, the flick gesture is being used to perform the function of closing all of the active applications. However, as previously described, the manage active apps mode may be configured to cause the active applications in the stack to be stopped, force stopped, quit, or deleted in response to a flick gesture (e.g., as shown in FIG. 3d).

After a flick gesture is performed on the stack to perform a function on all of the active applications (e.g., as shown in FIG. 3d), feedback may be provided to indicate to the user that the function has been performed, such as is shown in FIG. 3e. An animation is provided in FIG. 3e to indicate that all of the active applications have been closed. In particular, the animation shown in this example case is a fade out animation from the active apps screen shown in FIG. 3d to the home screen of the device shown in FIG. 3f. As previously described, the feedback may be visual, auditory, and/or tactile and the feedback (along with other features of the manage active apps mode) may be user-configurable, hard-coded, or some combination thereof. In some embodiments, the active applications may stay in a stack if the user exits or leaves the active apps screen (e.g., by pressing the home button) prior to performing a flick gesture (e.g., to close all of the active applications). In some such embodiments, when the user returns to the active apps screen, the previously formed stack of active applications will be displayed and may include any newly active applications since the stack was formed (or may not include them and have them separate from the stack). In other embodiments, the active applications may be restored to the original list if the user exits or leaves the active apps screen prior to flicking the stack to perform a function on all of the active applications (e.g., to close all of the active applications).

FIGS. 4a-c collectively illustrate an example manage active apps mode flick gesture where the direction of the flick determines the mode function performed, in accordance with an embodiment of the present invention. FIG. 4a illustrates an active apps screen with a stack of targeted active applications already formed using a pinch gesture as described herein (e.g., as shown in FIG. 3b). In this example embodiment, the direction of the flick gesture determines the function performed on those targeted applications and may include any combination of directions (e.g., up, down, left, right, or any other suitable direction) and functions (e.g., close apps, stop apps, force stop apps, quit apps, delete apps, or any other suitable function). As previously described, the flick direction and corresponding function performed may be user-configurable, hard-coded, or some combination thereof. In the example shown in FIG. 4b, two flick directions (left and right) have been assigned different functions (close apps and force stop apps, respectively). As shown, the flick options are displayed to assist the user (Flick Left to Close Apps and Flick Right to Force Stop Apps) after the user makes initial contact with the stack of active applications. In other embodiments, the flick options may not be displayed or otherwise provided to assist the user (and thus may include some degree of memorization). FIG. 4c shows the user performing a right flick gesture to flick the stack of targeted active applications off of the screen and force stop all of those applications.

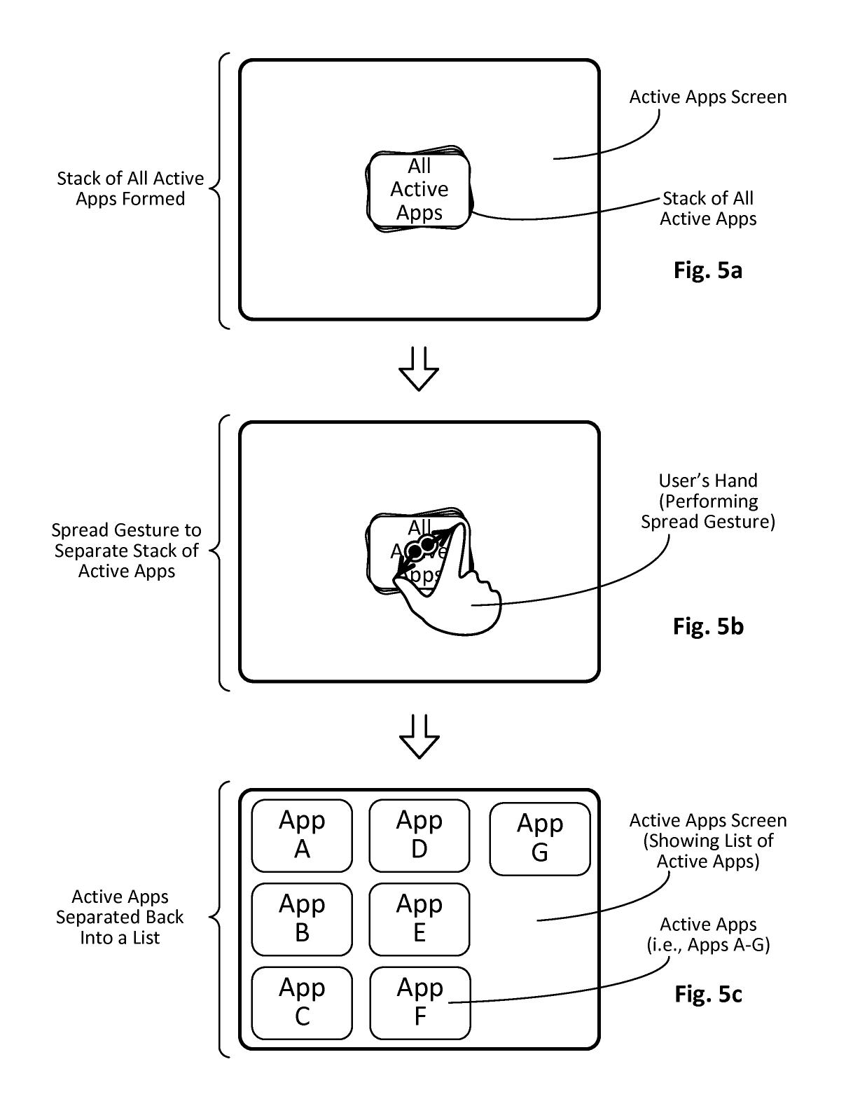

FIGS. 5a-c illustrate an example manage active apps mode separate action using a spread gesture to separate a previously formed stack of active applications, in accordance with an embodiment of the present invention. FIG. 5a illustrates an active apps screen with a stack of active applications already formed using a pinch gesture as described herein (e.g., as shown in FIG. 3b). In this example embodiment, an action can be used to separate a previously formed stack of active applications, thereby undoing the formation of the stack and restoring the active applications into a list (or in the format of how they were previously displayed, such as a group, menu, etc.). In the example shown in FIG. 5b, a spread gesture is being performed to separate the previously formed stack of active applications back into a list as shown in FIG. 5c. Since the stacked active applications were restored into the original list, the active apps screen showing the list of active applications in FIG. 5c is the same example screen shot shown in FIG. 3a. In other embodiments, different or additional actions may be used to separate a previously formed stack of active applications, such as a double tap on the stack, a press-and-hold on the stack, or exiting the active apps screen before flicking a formed stack, for example. Numerous different manage active apps mode examples and configurations will be apparent in light of this disclosure.

Methodology

FIG. 6 illustrates a method for providing a manage active apps mode in a touch sensitive computing device, in accordance with one or more embodiments of the present invention. This example methodology may be implemented, for instance, by the UI module of the touch sensitive device shown in FIG. 2a, or the touch sensitive device shown in FIG. 2b (e.g., with the UI provisioned to the client by the server). To this end, the UI and the manage active apps mode can be implemented in software, hardware, firmware, or any combination thereof, as will be appreciated in light of this disclosure.

The method generally includes sensing a user's input by a touch sensitive surface. In general, any touch sensitive device/interface may be used to detect contact (whether direct or proximate) with it by one or more fingers and/or styluses or other suitable implements. As soon as the user initiates contact with the touch sensitive surface/interface at one or more contact points, the UI can track the path of each contact point and determine the gesture(s) being performed, including the pinch and flick gestures variously described herein. The release point(s) can also be captured by the UI as they may be used to execute or to stop executing a function or action started when the user initiated contact with the touch sensitive surface (e.g., to form a stack of active applications after a pinch gesture is performed on an active apps screen or to select a flick function as determined by the direction of the flick). These main detections can be used in various ways to implement UI functionality, including a manage active apps mode as variously described herein, as will be appreciated in light of this disclosure.

In this example case, the method includes detecting 601 user contact at the touch sensitive interface. In general, the touch monitoring is effectively continuous. Although the method illustrated in FIG. 6 and described herein is in the context of user contact (whether direct or otherwise sufficiently proximate to the touch sensitive surface), the contact or input may be direct or proximate to include, e.g., hovering input. The method continues with determining 602 if an active apps screen is being displayed. As previously described, the active apps screen or active apps menu may be accessed by, for example, holding the device's home button, pushing an active or recent applications button, navigating to an applications menu, or some other suitable method. The active applications may be shown in a list, group, menu, or any other suitable format. If an active apps screen is not being displayed, then the method may continue with reviewing 603 for other input requests. If an active apps screen is being displayed, then the method can continue by determining 604 if a pinch gesture has been performed. If no pinch gesture has been performed, then the method continues by determining 605 if an active apps screen is still being displayed. If an active apps screen is still being displayed, then the method continues to review 604 for a pinch gesture until either a pinch gesture has been performed or the active apps screen is no longer being displayed. If the active apps screen is no longer being displayed, then the method may continue with reviewing 603 for other input requests.

If a pinch gesture has been performed while an active apps screen is being displayed, then the method continues with forming 606 the active applications into a stack. In some embodiments, determining 604 if a pinch gesture has been performed may include determining if the pinch gesture was performed on the active apps screen portion of the display, such as when the active apps screen does not take up the entire display area, or determining if the appropriate number of contact points were used in the pinch gesture, for example. Also, recall that a selection of a subset of the displayed active applications can be made as well, and/or some of the displayed apps may be exempt from the pinch and flick app management function. Once a recognizable pinch gesture has been performed to form 606 the targeted active applications into a stack, the method continues by determining 607 if a flick gesture has been performed on the stack. If a flick gesture has not been performed on the stack, the method determines 608 if an action to separate the stack has been performed. Actions used to separate the stack may include, for example, a spread gesture on the stack, a double tap gesture on the stack, or a press-and-hold gesture on the stack. In some embodiments, the manage active apps mode may be configured to separate a previously formed stack of active applications when a user exits or leaves the active apps screen (the active apps screen is no longer being displayed). In some such embodiments, any action that causes the active apps screen to be exited or left can also cause the stack to be separated. In other embodiments, the stack of active applications may remain in a stack even if the active apps screen was exited or left. As previously described, in some such embodiments, the stack may or may not include any newly active applications into the stack after it is formed, based on the configuration of the manage active apps mode.

If an action to separate the stack has been performed, the method continues back at step 605 by determining if an active apps screen is still being displayed. If an action to separate the stack has not been performed, the method continues to review 607 for a flick gesture performed on the stack until either a flick gesture has been performed on the stack or until the stack of active applications has been separated (e.g., through an action that separates the stack such as a spread gesture performed on the stack). If a flick gesture has been performed on a stack of active applications, then the method continues with performing 609 a function on all of the active applications in the stack. In some embodiments, determining 607 if a flick gesture has been performed may include determining if the flick gesture exceeds a certain speed or distance threshold, determining if the flick gesture caused the stack of active applications to go off of the screen or display, and/or determining if the appropriate number of flick contact points were used, for example. In some embodiments, determining 607 if a flick gesture has been performed may include determining if contact was maintain from the pinch gesture such that the pinch and flick were performed as one continuous gesture. As previously described, the function performed on all of the active applications in the flicked stack may include closing, stopping, force stopping, quitting, or deleting the active applications, for example. In some embodiments, characteristics of the flick gesture, such as the direction of the flick gesture, may determine the function performed. The function performed in response to a flick gesture performed on a stack of active applications may be user-configurable (e.g., see FIG. 1d), hard-coded, or some combination thereof.

The example method shown in FIG. 6 continues by determining 610 if the manage active apps mode is configured to provide feedback that the function has been performed on all of the active applications in the stack. If the manage active apps mode is configured to provide feedback, then the method continues by providing 611 the feedback as configured. As previously described, whether or not feedback is provided after a recognizable flick gesture may be user-configurable (e.g., see FIG. 1d), hard-coded, or some combination thereof. The feedback may be visual (e.g., an animation or transition effect), auditory (e.g., a sound or music), and/or tactile (e.g., haptic vibrations). The type of feedback provided may also be user-configurable (e.g., see FIG. 1d), hard-coded, or some combination thereof.

Regardless of whether the manage active apps mode is configured to provide feedback, the method of this example embodiment continues with a default action 612, such as displaying the device's home screen or doing nothing until further user contact/input. Likewise, the received contact can be reviewed for some other UI request, as done at 603. The method may continue in the touch monitoring mode indefinitely or as otherwise desired, so that any contact provided by the user when an active apps screen is displayed can be evaluated for use in the manage active apps mode, if appropriate. As previously described, the manage active apps mode may be user profile specific, such that it is only available, enabled, and/or active when certain user profiles are being used. In addition, the manage active apps mode may have different configurations for different user profiles, particularly where the manage active apps mode is user-configurable. In some embodiments, the manage active apps mode may only be available, enabled, and/or active when an active apps screen is displayed (e.g., when multiple active applications are displayed in a list, group, menu, or some other suitable format). In this manner, power and/or memory may be conserved since the manage active apps mode may only run or otherwise be available when an active apps screen is displayed.

Numerous variations and embodiments will be apparent in light of this disclosure. One example embodiment of the present invention provides a device including a display for displaying content to a user, a touch sensitive surface for allowing user input, and a user interface. The user interface includes the ability to interact with multiple applications, wherein a pinch gesture performed on the touch sensitive surface forms a stack of active applications and a flick gesture on the touch sensitive surface performs a function on all of the active applications in the stack. In some cases, the flick gesture on the touch sensitive surface performs one of closing, stopping, force stopping, quitting, and deleting all of the active applications in the stack. In some cases, the display is a touch screen display that includes the touch sensitive surface. In some cases, the flick gesture causes the stack to go off of the display. In some cases, the direction of the flick gesture determines the function performed with respect to all of the active applications in the stack. In some cases, at least one of a spread gesture, double tap gesture, and press-and-hold gesture performed on the touch sensitive surface separates the stack into the original display of active applications. In some cases, feedback is provided after the flick gesture to indicate that the function has been performed, the feedback being visual, auditory, and/or tactile. In some cases, the pinch gesture and flick gesture are made using one continuous gesture. In some cases, a flick gesture performed on a single active application performs one of closing, stopping, force stopping, quitting, and deleting the single active application.

Another example embodiment of the present invention provides a mobile computing device including a display having a touch screen interface and for displaying content to a user, and a user interface. The user interface includes a manage active apps mode that can be invoked in response to user input via the touch sensitive surface. The user input includes a pinch gesture performed on an active apps screen that displays active applications (wherein the pinch gesture causes the active applications to form into a stack) and a flick gesture performed on the stack, wherein the manage active apps mode is configured to perform one of a close, stop, force stop, quit, and delete function on all of the active applications in the stack when invoked. In some cases, the function performed is determined by the direction of the flick gesture. In some cases, the flick gesture includes dragging the stack until a portion of the stack is off of the active apps screen. In some cases, the stack is separated into the original display of active applications when the active apps screen is exited. In some cases, the manage active apps mode is user-configurable.

Another example embodiment of the present invention provides a computer program product including a plurality of instructions non-transiently encoded thereon to facilitate operation of an electronic device according to a process. The computer program product may include one or more computer readable mediums such as, for example, a hard drive, compact disk, memory stick, server, cache memory, register memory, random access memory, read only memory, flash memory, or any suitable non-transitory memory that is encoded with instructions that can be executed by one or more processors, or a plurality or combination of such memories. In this example embodiment, the process is configured to form a stack of active applications in response to a first user input via a touch sensitive interface of a device capable of displaying content (wherein the first user input includes a pinch gesture performed on the touch sensitive surface), and perform a function on the active applications in the stack in response to a second user input via the touch sensitive interface (wherein the second user input includes a flick gesture). In some cases, the function invoked is one of closing, stopping, force stopping, quitting, and deleting all of the active applications in the stack. In some cases, the direction of the flick gesture determines the function performed. In some cases, at least one of a spread gesture, double tap gesture, and press-and-hold gesture performed on the stack of active applications separates the stack into the original display of active applications. In some cases, the touch sensitive surface is a touch screen display. In some cases, feedback is provided after the flick gesture to indicate that the function was performed, the feedback being visual, auditory, and/or tactile.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A device, comprising:
a display for displaying content to a user;
a touch sensitive surface for allowing user input; and
a user interface including the ability to interact with multiple applications, wherein a pinch gesture performed on the touch sensitive surface forms a stack of active applications and a flick gesture on the touch sensitive surface performs a function on all of the active applications in the stack.

2. The device of claim 1 wherein the flick gesture on the touch sensitive surface performs one of closing, stopping, force stopping, quitting, and deleting all of the active applications in the stack.

3. The device of claim 1 wherein the display is a touch screen display that includes the touch sensitive surface.

4. The device of claim 1 wherein the flick gesture causes the stack to go off of the display.

5. The device of claim 1 wherein the direction of the flick gesture determines the function performed with respect to all of the active applications in the stack.

6. The device of claim 1 wherein at least one of a spread gesture, double tap gesture, and press-and-hold gesture performed on the touch sensitive surface separates the stack into the original display of active applications.

7. The device of claim 1 wherein feedback is provided after the flick gesture to indicate that the function has been performed, the feedback being visual, auditory, and/or tactile.

8. The device of claim 1 wherein the pinch gesture and flick gesture are made using one continuous gesture.

9. The device of claim 1 wherein a flick gesture performed on a single active application performs one of closing, stopping, force stopping, quitting, and deleting the single active application.

10. A mobile computing device, comprising:
a display having a touch screen interface and for displaying content to a user; and
a user interface including a manage active apps mode that can be invoked in response to user input via the touch sensitive surface, the user input comprising:
a pinch gesture performed on an active apps screen that displays active applications, wherein the pinch gesture causes the active applications to form into a stack; and
a flick gesture performed on the stack;
wherein the manage active apps mode is configured to perform one of a close, stop, force stop, quit, and delete function on all of the active applications in the stack when invoked.

11. The device of claim 10 wherein the function performed is determined by the direction of the flick gesture.

12. The device of claim 10 wherein the flick gesture includes dragging the stack until a portion of the stack is off of the active apps screen.

13. The device of claim 10 wherein the stack is separated into the original display of active applications when the active apps screen is exited.

14. The device of claim 10 wherein the manage active apps mode is user-configurable.

15. A computer program product comprising a plurality of instructions non-transiently encoded thereon to facilitate operation of an electronic device according to the following process, the process comprising:
form a stack of active applications in response to a first user input via a touch sensitive interface of a device capable of displaying content, wherein the first user input includes a pinch gesture performed on the touch sensitive surface; and
perform a function on the active applications in the stack in response to a second user input via the touch sensitive interface, wherein the second user input includes a flick gesture.

16. The computer program product of claim 15 wherein the function invoked is one of closing, stopping, force stopping, quitting, and deleting all of the active applications in the stack.

17. The computer program product of claim 15 wherein the direction of the flick gesture determines the function performed.

18. The computer program product of claim 15 wherein at least one of a spread gesture, double tap gesture, and press-and-hold gesture performed on the stack of active applications separates the stack into the original display of active applications.

19. The computer program product of claim 15 wherein the touch sensitive surface is a touch screen display.

20. The computer program product of claim 15 wherein feedback is provided after the flick gesture to indicate that the function was performed, the feedback being visual, auditory, and/or tactile.
